(19) United States
(12) Patent Application Publication
(10) Pub. No.: US 2013/0138803 A1
(43) Pub. Date: May 30, 2013

(54) METHOD FOR MONITORING A PLURALITY OF RACK SYSTEMS

(71) Applicant: Hao-Hao Wang, Shanghai City (CN)

(72) Inventor: Hao-Hao Wang, Shanghai City (CN)

(73) Assignee: INVENTEC CORPORATION, Taipei City (TW)

(21) Appl. No.: 13/397,063

(22) Filed: Feb. 15, 2012

(30) Foreign Application Priority Data
Nov. 28, 2011 (CN) 201110385465.X

(51) Int. Cl. G06F 15/173

(52) U.S. Cl. 709/224

(57) ABSTRACT

A method for monitoring a plurality of rack systems is provided, which includes the following steps. The rack systems are provided, in which each rack system includes an integrated management module (IMM) and a plurality of servers, and the IMM is communicatively connected to the servers and manages and controls the servers. The rack systems are distributed into at least one rack system group, in which each rack system group includes a first rack system and a second rack system, and the first rack system and the second rack system respectively include a first IMM and a second IMM. The first IMM and the second IMM are communicatively connected, monitor each other, and judge whether an anomaly occurs in each other. When the first IMM judges that an anomaly occurs, the first IMM sends a warning message including the anomaly of the second rack system.

### CROSS-REFERENCE TO RELATED APPLICATION

This application claims the priority benefit of China application serial no. 201110385465.X, filed on Nov. 28, 2011. The entirety of the above-mentioned patent application is hereby incorporated by reference herein and made a part of this specification.

### BACKGROUND OF THE INVENTION

1. Field of the Invention

The present invention generally relates to a rack system of servers, in particular, to a method for monitoring a plurality of rack systems.

2. Description of Related Art

Many enterprises provide many servers according to cloud services provided by the enterprises or service requirements, and integrate the servers into rack systems that can be managed in a centralized way, so as to reduce the management cost of the servers.

FIG. 1 is a schematic block diagram of a rack system 100. A network switch 120 and a plurality of servers 110_1-110_{—}n are placed inside the rack system 100. The servers 110_1-110_{—}n each have a network port, and the network ports are all connected to the network switch 120.

The servers 110_1-110_{—}n are connected to an Internet 10 through the network switch 120, and the Internet 10 can also be referred to as a serving network. Each server is an independent computer system. For example, the servers 110_1-110_{—}n each include a power supply, a baseboard management controller (BMC), and a plurality of fans for heat dissipation. In the conventional rack system 100, each of the servers 110_1-110_{—}n manages its own power supply and fans through the BMC, so as to manage and control the internal power consumption and temperature thereof.

Since relevant devices in the entire rack system 100 need to be managed, the rack system 100 is further provided with a management module. A large number of rack apparatuses are placed in the same area, and the management module is very important to the rack apparatuses, so management personnel hope to know immediately the abnormal rack apparatus when an anomaly or failure occurs in a certain management module, so as to remove the anomaly right away. However, the current management module cannot report a failure of its own in time when the failure occurs. Therefore, manufacturers all hope to conduct research and development on relevant technologies to solve the above problem.

### SUMMARY OF THE INVENTION

Accordingly, the present invention is directed to a method for monitoring a plurality of rack systems, in which the rack systems are grouped and IMMs in the same group judge whether an anomaly occurs in each other, so as to send a warning message to management personnel in time upon judging that an anomaly occurs, thereby facilitating centralized management of servers.

The present invention provides a method for monitoring a plurality of rack systems. The monitoring method includes the following steps. The rack systems are provided, in which each rack system includes an integrated management module (IMM) and a plurality of servers, and the IMM is communicatively connected to the servers in the rack system and manages and controls the servers. The rack systems are distributed into at least one rack system group, in which each rack system group includes a first rack system and a second rack system, and the first rack system and the second rack system respectively include a first IMM and a second IMM. The first IMM and the second IMM are communicatively connected, monitor each other, and judge whether an anomaly occurs in each other. When the first IMM judges that an anomaly occurs, a warning message including the anomaly of the second rack system is sent.

In an embodiment of the present invention, the monitoring method further includes the following step. When the first IMM judges that the anomaly occurs, the first IMM detects a communication link from the first IMM to the second IMM to generate a detection result.

In an embodiment of the present invention, the monitoring method further includes the following step. When it is determined that the second IMM has operated abnormally, the first IMM temporarily manages and controls a plurality of devices of the second rack system that are originally managed and controlled by the second IMM.

Based on the above, in the embodiments of the present invention, the rack systems are distributed into rack system groups each having two rack systems, and IMMs in the same rack system group monitor each other and judge whether an anomaly occurs. Thereby, when a failure occurs in a certain IMM or in a communication link of a certain network segment, another IMM can report the failure to management personnel of a remote integrated management center in time. In addition, an IMM in the same group can temporarily take the place of the failed IMM, so as to further achieve the purpose of backing up each other.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a rack system.

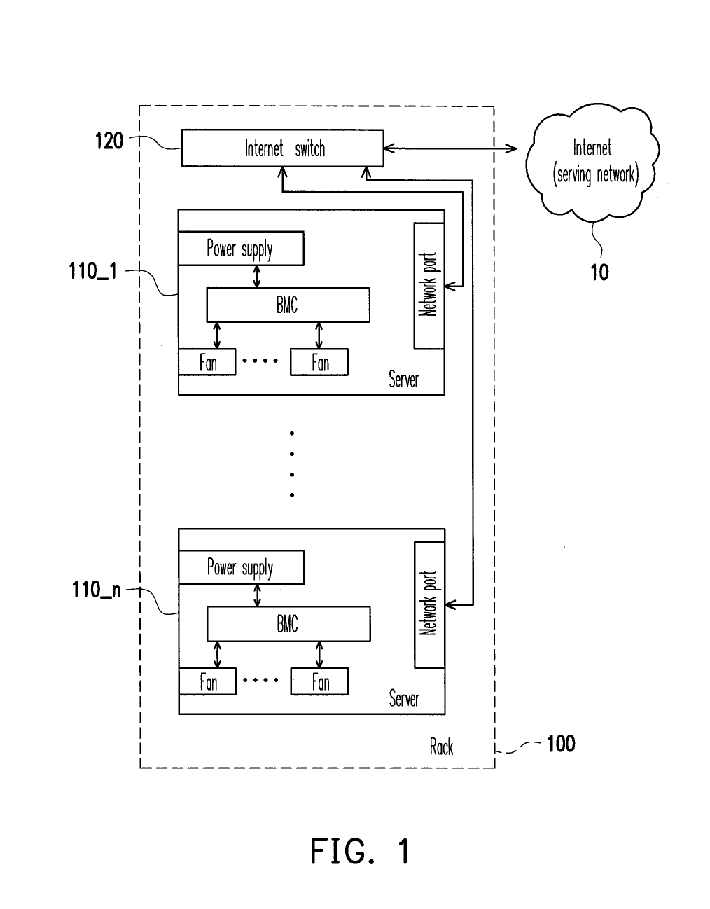

FIG. 2 is a flow chart of a method for monitoring a plurality of rack systems according to an embodiment of the present invention.

FIG. 3 is a schematic diagram of a plurality of rack systems according to an embodiment of the present invention.

FIG. 4 is a schematic diagram of functional modules of a rack system group according to an embodiment of the present invention.

FIG. 5 is a schematic diagram of functional modules of a rack system group according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Conventionally, each rack system only has a single IMM, or can only be provided with a plurality of IMMs to back up each other, so as to avoid damage due to a failure of an IMM.

Accordingly, the spirit of embodiments of the present invention lies in that, in the case of a plurality of rack systems, the rack systems are grouped, and two rack systems are classified as one rack system group, and IMMs in each rack system group can judge whether an anomaly occurs in each other through a network, and report an anomaly in time when finding the anomaly, thereby facilitating centralized management of the rack systems and servers.

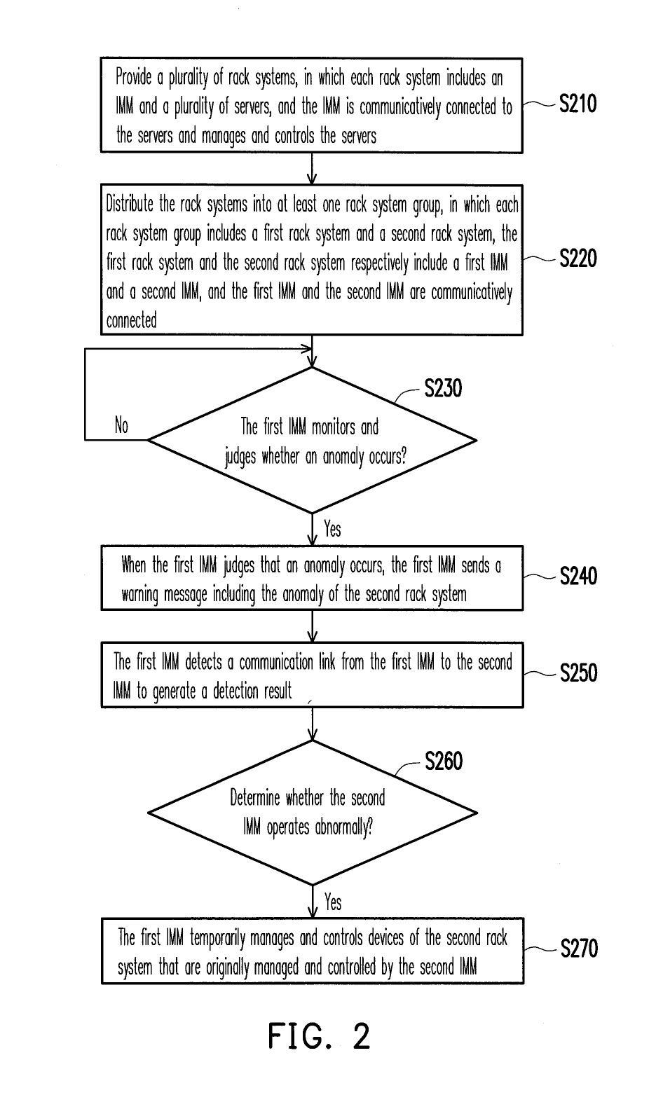

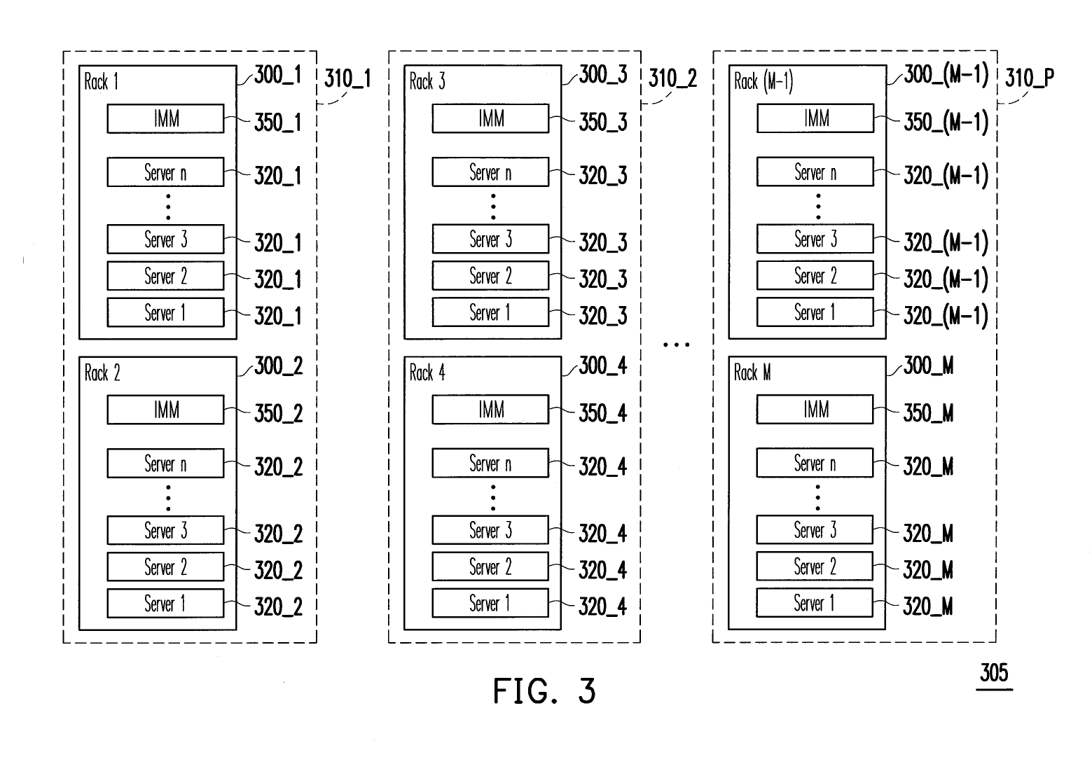

FIG. 2 is a flow chart of a method for monitoring a plurality of rack systems according to an embodiment of the present invention. FIG. 3 is a schematic diagram of a plurality of rack systems 300_1-300_M according to an embodiment of the present invention, wherein M is a positive integer. The monitoring method described in FIG. 2 is applicable to the plurality of rack systems 300_1-300_M in FIG. 3. In this embodiment, M is preferably, but not limited to, an even number. In addition, for ease of description, the rack systems 300_1-300_M are respectively referred to as Rack 1 to Rack M in FIG. 3 and the following description in this embodiment.

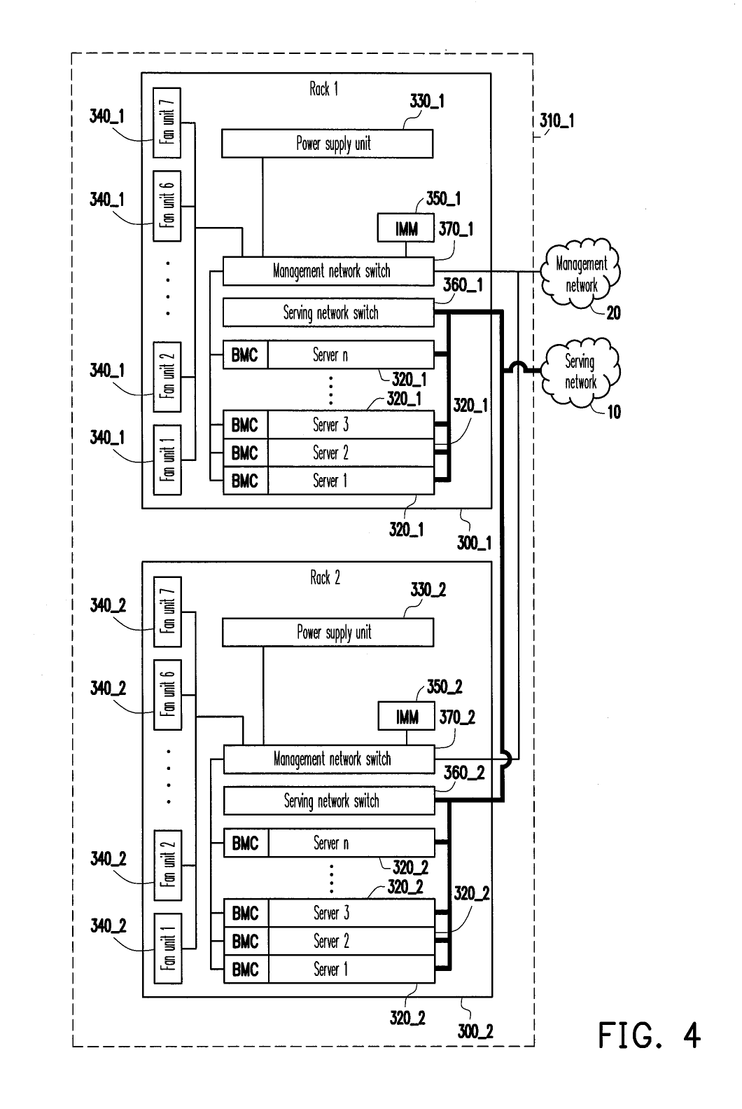

Many manufacturers place numerous rack systems 300_1-300_M in the same area, for example, a container 305, to facilitate centralized management and unified movement of the rack systems 300_1-300_M. Therefore, the rack systems 300_1-300_M may be referred to as container computers. In this embodiment, the detailed structure of each of the rack systems 300_1-300_M will be provided in FIG. 4 and the relevant description thereof. The rack systems 300_1-300_M shown herein respectively include IMMs 350_1-350_M and a plurality of servers 320_1-320_M.

Referring to FIG. 2 and FIG. 3 at the same time, in Step S210, in this embodiment, the rack systems 300_1-300_M are erected in the container 305 to provide Rack 1 to Rack M. The IMMs 350_1-350_M are respectively communicatively connected to servers 320_1-320_M located in each of the rack systems 300_1-300_M, and manage and control the servers 320_1-320_M. For example, the IMM 350_1 is communicatively connected to a plurality of servers 320_1 located in Rack 1 so as to manage and control the servers 320_1; the IMM 350_2 is communicatively connected to a plurality of servers 320_2 located in Rack 2 so as to manage and control the servers 320_2, and it is the same with Rack 1 to Rack M. In addition, the IMMs 350_1-350_M may also be connected to each other through a management network.

In Step S220, the rack systems 300_1-300_M are distributed, so as to divide the rack systems 300_1-300_M into at least one rack system group 310_1-310_P, where P is a positive integer and P may be equal to M/2. Each of the rack system groups 310_1-310_P has two rack systems in pair, for example, the rack system group 310_1 has Rack 1 and Rack 2, and the rack system group 310_2 has Rack 3 and Rack 4.

Rack 1 to Rack M in each of the rack system groups 310_1-310_P all have respective IMMs 350_1-350_M, and the IMMs 350_1-350_M in the same rack system group 310_1-310_P are communicatively connected to each other.

It should be particularly noted that, in Step S220, the distributed structure of the IMMs 350_1-350_M may be used for automatic grouping. In other words, in this embodiment, the rack systems 300_1-300_P can be automatically distributed through communication between the IMMs 350_1-350_M. For example, each of the IMMs 350_1-350_M may create a rack information sheet by itself, write a relevant feature value of the IMM 350_1-350_M (for example, a name, a serial number, a network protocol address, and/or a media access control address of each of the IMMs) in the rack information sheet, and transfer its own feature value to neighboring IMMs through the management network, so as to improve the rack information sheet of each of the IMMs 350_1-350_M. Then, the IMMs 350_1-350_M can match corresponding IMMs 350_1-350_M automatically according to their own grouping judgment programs, so that every two rack systems can be distributed into the same rack system group.

In other embodiments, all the IMMs 350_1-350_M may also be connected to a remote integrated management center, and the remote integrated management center is used to group the rack systems in a unified way, which will not be described herein again.

FIG. 4 is a schematic diagram of functional modules of the rack system group 310_1 according to an embodiment of the present invention. The subsequent relevant operation manners are described by taking the rack system group 310_1 in FIG. 4 as an example with reference to the flow chart of FIG. 2. In this embodiment, the rack system group 310_1 has a rack system 300_1 and a rack system 3002. In FIG. 4, the rack system 300_1 and the rack system 300_2 respectively include IMMs 350_1-350_2, a plurality of servers 320_1-320_2, at least one power supply unit 330_1-330_2, a plurality of fan units 340_1-340_2, serving network switches 360_1-360_2, and management network switches 370_1-370_2. Since the structures of Rack 1 and Rack 2 are the same, Rack 1 is taken as an example below. In addition, Rack 2 to Rack M can be derived from Rack 1.

The servers 320_1 each have a serving network port. A plurality of network connection ports of the serving network switch 360_1 is respectively connected to the serving network ports of the servers 320_1. As a result, the servers 320_1 can provide services to a serving network 10 (for example, the Internet) through the serving network switch 360_1. In addition, the serving network switches 360_1-360_2 also located in the rack system group 310_1 are also connected to each other using respective network connection ports.

The servers 320_1 each have a BMC, and the BMCs each have a management network port. The BMC is a well-known technology of servers, and will not be described herein again. The management network ports of the BMCs are each connected to one of a plurality of network connection ports of the management network switch 370_1. The management network switch 370_1 is coupled to the management network 20. In addition, the management network switches 370_1-370_2 also located in the rack system group 310_1 are also connected to each other using respective network connection ports. The management network 20 may be a local area network (LAN), for example, an Ethernet. Therefore, the management network switches 370_1-370_2 may be Ethernet switches or other LAN switches.

A management network port of the IMM 350_1 is connected to the management network switch 370_1. In Rack 1, the IMM 350_1 communicates with the BMCs of the servers 320_1 through the management network switch 370_1, so as to obtain operation states of the servers 320_1 (for example, the operation state such as an internal temperature of the servers), and/or control operations of the servers 320_1 (for example, control operations such as start-up, shut-down, and firmware update of the servers).

The rack system 300_1 is provided with at least one power supply unit 330_1. The power supply unit 330_1 provides electric energy to apparatuses in Rack 1. For example, the power supply unit 330_1 supplies power to the management network switch 370_1, the serving network switch 360_1, the servers 320_1, the fan units 340_1, and the IMM 350_1 in Rack 1. The power supply unit 330_1 has a management network port, and the management network port is connected to the management network switch 370_1. The plurality of fan units 340_1 also has management network ports. The management network ports of the fan units 340_1 are connected to the management network switch 370_1.

Thereby, the IMM 350_1 can communicate with the power supply unit 330_1 and the fan units 340_1 through the management network switch 370_1, so as to obtain operation states of the power supply unit 330_1 and the fan units 340_1 and/or control operations of the power supply unit 330_1 and the fan units 340_1. For example, the IMM 350_1 can obtain relevant power consumption information and fan operation information of the servers, the rack system 300_1, and the fan units 340_1, for example, obtain power consumption of all servers 320_1 and fan rotation speed of the fan units 340_1, through the management network switch 370_1. According to the power consumption information or fan operation information, the IMM 350_1 delivers a control command to the power supply unit 330_1 and the fan units 340_1 through the management network switch 370_1, so as to control/adjust the power output of the power supply unit 330_1 or control/adjust the fan rotation speed of the fan units 340_1.

The rack system 300_2 (Rack 2) also includes an IMM 350_2, a plurality of servers 320_2, a power supply unit 330_2, fan units 340_2, a serving network switch 360_2, and a management network switch 370_2. The functions of the devices are all the same as those of the corresponding devices in Rack 1, and will not be described herein again.

Referring back to FIG. 2, the method for monitoring a plurality of rack systems in this embodiment is further described with reference to FIG. 4. Since the grouping has been completed, and Rack 1 and Rack 2 are classified as one rack system group 310_1, in Step S230, the IMM 350_1 (a first IMM) in Rack 1 and the IMM 350_2 (a second IMM) in Rack 2 monitor each other and judge whether an anomaly occurs in each other. The so-called “anomaly” herein may be the situation that a network link between the IMM 350_1 and the IMM 350_2 cannot be connected, the management network switch 370_1 or 370_2 is damaged and thus disconnected, the IMM 350_1 or 350_2 is failed, or the like.

In this embodiment, the management network switches 370_1-370_2 are connected to each other through the management network and more than one network node (for example, the management network switches 370_1-370_2), so as to implement communication between the IMMs 350_1-370_2 and monitoring between them. Therefore, in Step S230, the IMM 350_1 (the first IMM) in Rack 1 sends an acknowledgement request to the IMM 350_2 in Rack 2 periodically, and receives an acknowledgement response returned by the IMM 350_2, so as to acknowledge whether the network link from the IMM 350_1 to the IMM 350_2 is smooth and meanwhile acknowledge that no anomaly occurs in the IMM 350_2.

If the IMM 350_1 does not receive the acknowledgement response returned by the IMM 350_2 occasionally, for example, the number of times that the IMM 350_1 does not receive the acknowledgement response continuously is smaller than a threshold, it is possible that the IMM 350_2 at that time is already fully loaded, and the network link is too congested so that the acknowledgement response cannot be received for the moment. The situation is allowed to occur occasionally. However, if the number of times that the IMM 350_1 does not receive the acknowledgement response continuously is greater than the threshold, the IMM 350_1 has to judge that an anomaly already occurs.

In similar embodiments, the IMM 350_1 may also judge whether an anomaly occurs by monitoring a communication connection status of the IMM 350_2. In other words, since the IMM 350_2 is communicatively connected to the servers 320_2 periodically, the IMM 350_1 can judge whether an anomaly occurs in the IMM 350_2 or in the network link from the IMM 350_1 to the IMM 350_2 by monitoring the status of receiving/sending a network packet by the IMM 350_2.

When the IMM 350_1 (the first IMM) judges that an anomaly occurs, the process proceeds from Step S230 to Step S240, in which the IMM 350_1 sends a warning message including the anomaly of the rack system 320_2 to a remote integrated management center on the management network, thereby enabling management personnel maintaining the rack systems 300_1-300_M to immediately know the occurrence of the anomaly so as to remove the anomaly right away. The warning message may include an email message, a system log, and/or a Simple Network Management Protocol (SNMP) Trap message, and the type of the warning message is not limited in the embodiment of the present invention.

Then, in Step S250, when the IMM 350_1 has judged that an anomaly occurs, the IMM 350_1 begins to detect a communication link from the IMM 350_1 to the IMM 350_2 to generate a detection result. In particular, the IMM 350_1, at this time, will detect communication with the management network switch 370_1, communication with the management network switch 370_2, and communication with the IMM 350_2 in turn to see whether they are normal, and integrate the communication statuses, so as to generate the detection result. Meanwhile, the IMM 350_1 may upload the detection result and the warning message to the remote integrated management center, so that the management personnel can make recovery from the anomaly.

In addition, when the IMM 350_1 (the first IMM) determines that the IMM 350_2 (the second IMM) has operated abnormally by detection in turn in Step S260, the process proceeds to Step S270, in which the IMM 350_1 temporarily manages and controls devices of Rack 2 that are originally managed and controlled by the IMM 350_2, for example, the power supply unit 330_2, the fan units 340_2, and the like, through the management network.

In particular, when no anomaly occurs, the IMM 350_1 in Rack 1 and the IMM 350_2 in Rack 2 not only judge whether an anomaly occurs in each other, but also back up each other's management information. For example, the IMM 350_1 backs up the management information of Rack 1 in the IMM 350_2, and the IMM 350_2 also backs up the management information of Rack 2 in the IMM 350_1. When a failure occurs in the IMM 350_2, the IMM 350_1, upon detecting the anomaly, can use the management data backed up in the IMM 350_2 to temporarily manage and control devices in Rack 2, thereby achieving the purpose of backing up each other.

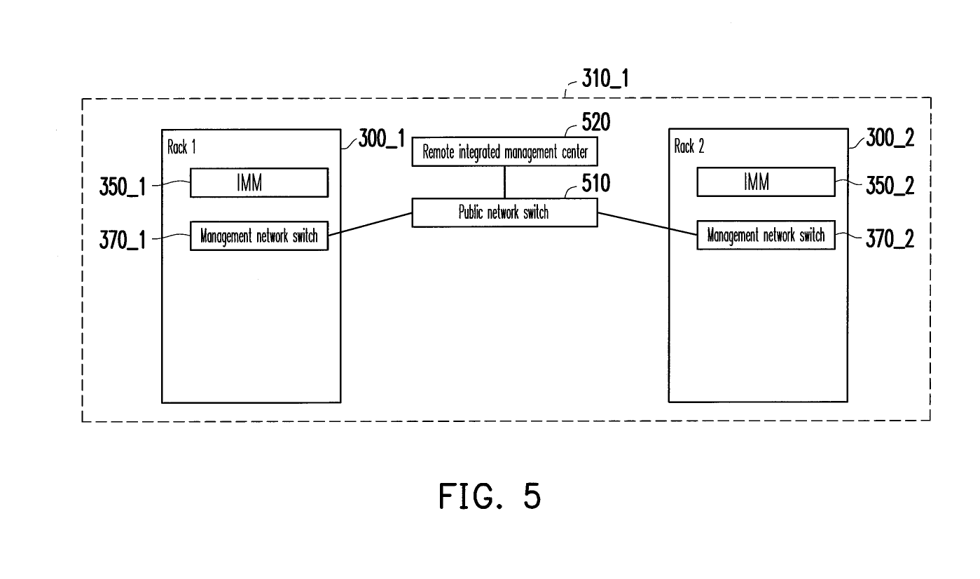

FIG. 5 is a schematic diagram of functional modules of the rack system group 310_1 according to another embodiment of the present invention. The embodiment of the present invention is similar to the above embodiment, and the same description will not be provided herein again. In addition, the rack systems 300_1 and 300_2 in FIG. 5 are the same as the rack systems 300_1 and 300_2 in FIG. 4, and in Rack 1 and Rack 2 of FIG. 5, only the IMMs 350_1-350_2 and the management network switches 370_1-370_2 are shown, with other elements omitted. Thereby, the difference between this embodiment and the above embodiment lies in that, the management network switches 370_1-370_M in the rack systems 300_1-300_M are all connected to a plurality of network connection ports of a public network switch 510 through respective network connection ports, and a management network port of a remote integrated management center 520 is also connected to the public network switch 510.

Therefore, since the IMMs 350_1-350_M are all connected to the remote integrated management center 520, in this embodiment, the remote integrated management center 520 can be used to group the rack systems in a unified way. In addition, the IMMs 350_1 and 350_2 are communicatively connected through the management network switches 370_1 and 370_2 and the public network switch 510, so as to monitor each other and judge whether an anomaly occurs in each other. When the IMM 350_1 judges that an anomaly occurs, the IMM 350_1 detects communication with the management network switch 370_1, communication with the public network switch 510, communication with the management network switch 370_2, and communication with the IMM 350_2 in turn to see whether they are normal, so as to generate a detection result (Step S250). Meanwhile, the IMM 350_1 uploads the detection result and the warning message to the remote integrated management center 520, so that the management personnel can remove an anomaly and make recovery rapidly just by continuously monitoring whether the remote integrated management center sends a warning message.

To sum up, in the embodiments of the present invention, the rack systems 300_1-300_M are distributed into rack system groups 310_1-310_P each having two rack systems, and IMMs in the same rack system group, for example, the IMM 350_1 and 350_2, monitor each other and judge whether an anomaly occurs. Thereby, when a failure occurs in a certain IMM or in a communication link of a certain network segment, another IMM can report the failure to the management personnel of the remote integrated management center in time. In addition, when it is judged that an IMM is really failed, an IMM in the same group can temporarily take over the failed IMM, so as to further achieve the purpose of backing up each other.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for monitoring a plurality of rack systems, comprising:
providing the rack systems, wherein each rack system comprises an integrated management module (IMM) and a plurality of servers, and the IMM is communicatively connected to the servers and manages and controls the servers;
distributing the rack systems into at least one rack system group, wherein each rack system group comprises a first rack system and a second rack system, and the first rack system and the second rack system respectively comprise a first IMM and a second IMM;
the first IMM and the second IMM being communicatively connected, monitoring each other, and judging whether an anomaly occurs in each other; and
when the first IMM judges that an anomaly occurs, sending a warning message comprising the anomaly of the second rack system.

2. The monitoring method according to claim 1, further comprising:
when the first IMM judges that the anomaly occurs, the first IMM detecting a communication link from the first IMM to the second IMM to generate a detection result.

3. The monitoring method according to claim 2, wherein in the first rack system, the first IMM communicates with the servers in the first rack system through a first network switch; in the second rack system, the second IMM communicates with the servers in the second rack system through a second network switch, and the first network switch and the second network switch are connected to each other to implement communication between the first IMM and the second IMM; and
when the first IMM judges that the anomaly occurs, the first IMM detects communication with the first network switch, communication with the second network switch, and communication with the second IMM in turn to see whether they operate normal, so as to generate the detection result.

4. The monitoring method according to claim 2, wherein the first IMM communicates with the second IMM through a public network switch, a remote integrated management center is connected to the public network switch, and the first IMM uploads the warning message and the detection result to the remote integrated management center.

5. The monitoring method according to claim 1, wherein the step of distributing the rack systems comprises:
matching the corresponding IMMs automatically according to at least one feature value of the IMMs, so that every two rack systems are distributed into the same group.

6. The monitoring method according to claim 5, wherein the feature value is a name, a network protocol address, and/or a media access control address of each of the IMMs.

7. The monitoring method according to claim 1, wherein the step of the first IMM and the second IMM monitoring each other comprises:
the first IMM sending an acknowledgement request to the second IMM periodically, and receiving an acknowledgement response transferred by the second IMM; and
when the number of times that the first IMM does not receive the acknowledgement response is greater than a threshold, the first IMM judging that an anomaly occurs.

8. The monitoring method according to claim 1, wherein the step of the first IMM and the second IMM monitoring each other comprises:
the first IMM monitoring a communication connection status of the second IMM to judge whether an anomaly occurs.

9. The monitoring method according to claim 1, wherein the first IMM and the second IMM monitor each other through network connection and at least one network node.

10. The monitoring method according to claim 1, wherein the warning message comprises a mail message, a system log, and/or a Simple Network Management Protocol (SNMP) Trap message.

11. The monitoring method according to claim 1, further comprising:
when determining that the second IMM has operated abnormally, the first IMM temporarily managing and controlling a plurality of devices of the second rack system that are originally managed and controlled by the second IMM.
